(19) United States
(12) Patent Application Publication
(10) Pub. No.: US 2023/0138875 A1
(43) Pub. Date: May 4, 2023

(54) PLASMA PROCESS TO CONVERT SPENT POT LINING (SPL) TO INERT SLAG, ALUMINUM FLUORIDE AND ENERGY

(71) Applicant: PYROGENESIS CANADA INC., Montréal (CA)

(72) Inventors: Jean-René GAGNON, Boisbriand (CA); Ali SHAHVERDI, Verdun (CA); François RIVARD, Montréal (CA); François PICARD, Montréal (CA); Pierre CARABIN, Montréal (CA)

(21) Appl. No.: 17/913,308

(22) PCT Filed: Mar. 22, 2021
(86) PCT No.: PCT/CA2021/050377

§ 371 Date: Sep. 21, 2022

Related U.S. Application Data
(60) Provisional application No. 62/993,043, filed on Mar. 22, 2020.

(51) Int. Cl. C01F 7/50; H05H 1/48; B09B 3/50; B09B 3/70; B09B 5/00; C01F 7/302; C04B 18/14; C10J 3/57; C10K 1/02

(52) U.S. Cl. CPC C01F 7/50; H05H 1/48; B09B 3/50; B09B 3/70; B09B 5/00; C01F 7/302; C04B 18/144; C10J 3/57; C10K 1/026; C10K 1/024; H05H 2245/80; C10J 2300/1238; C10J 2300/0956; C10J 2300/0976; C10J 2300/1634; C10J 2300/0996

(57) ABSTRACT

Apparatus for converting Spent Pot Lining (SPL) into inert slag, aluminum fluoride and energy includes a plasma arc furnace such that the destruction of SPL occurs therein. The furnace generates an electric arc within the waste, which arc travels from an anode to a cathode and destroys the waste due to the arc's extreme temperature, thereby converting a mineral fraction of SPL into vitrified inert slag lying within a crucible of the furnace. The furnace gasifies the carbon content of the SPL and produces a well-balanced syngas. The gasification takes place due to the controlled intake of air and steam into the furnace. The gasification reaction liberates significant amount of energy. Steam captures this excess energy, to provide part of the oxygen requirement for gasification and to contribute to raise the syngas H2 content. Steam also contributes to converting some SPL fluorides (NaF and Al2F3) into hydrogen fluoride. The plasma SPL processing system is compact (occupying less area than some competitive methods of SPL treatment), can be installed in close proximity to the aluminium plant (minimizing transportation of SPL and AlF3), and requires only electricity as its energy source and thus no fossil fuels.

### CROSS REFERENCE TO RELATED APPLICATIONS

This application claims priority on U.S. Provisional Application No. 62/993,043, now pending, filed on Mar. 22, 2020, which is herein incorporated by reference.

### FIELD

The present subject matter relates to the production of inert slag, aluminum fluoride (AlF₃) and energy and, more particularly, by converting Spent Pot Lining (SPL).

### BACKGROUND

### Problem Statement

In core aluminum manufacturing processes, a high-temperature electrolysis cell converts alumina to aluminum metal. The cell, colloquially called pot, is lined with carbon (the cathode) and with multiple layers of refractory bricks (FIG. 1). The electrolyte within the cell dissolves slowly into the cell wall over time. This electrolyte dissolution causes the cell to fail after 5 to 8 years of service¹. There is no way to fix or recycle back to the smelter a contaminated cell wall (called spent pot lining or SPL). Thus, the contaminated cell wall becomes the largest solid waste stream from any aluminum smelter².

An aluminum smelter produces up to 25,000 tons of SPLs per year³. All the 270 or so aluminum smelters around the world must handle such waste stream, which amounts to more than 1,500,000 metric tons per year worldwide. The SPL is a hazardous residual material because of its high content of leachable fluorides and cyanides. Moreover, SPL reacts with water to generate explosive gases, such as methane and hydrogen. Hence, transportation, remediation and final storage of SPL is subject to strict regulations. SPL is highly heterogeneous⁵, which complicates any recycling treatment. Still today, due to these considerations, the most common route to treat SPL is to dump it directly into highly secured (and expensive) landfills.

Commercial Alternatives to SPL Landfill

Many companies have worked to develop processes to decontaminate SPL, to recover or valorize the SPL carbon value and to recover the SPL fluoride value. The process alternatives to landfilling divide into either leaching or thermal destruction. Both alternatives have advantages and disadvantages. The most advanced decontamination processes for each process alternative are described hereinbelow.

Leaching: SPL decontamination and carbon recycling via low-caustic leaching and liming (LCL&L)

A major current alternative to SPL landfilling (or forever storage) is the low-caustic leaching and liming (LCL&L) process⁶. Rio Tinto currently operates an 80,000-ton/year LCL&L plant in the Saguenay region, Quebec. The process has the uttermost advantage of having already been through a difficult and long scale-up. Nonetheless, the process suffers from its complexity.

The following describes some of the process' complexity:
the process requires several complex equipment, such as a multi-effect evaporator, a pressure reactor and a crystallizer, which are difficult to operate.
the cyanide control is very complex and requires a complete wastewater treatment unit.
grinding the contaminated and dangerous SPL to 300 μm (microns) is tantamount to an efficient leaching process. SPL dust is explosive and thus a stringent dust control is required.
leaching a reduced waste with metallic aluminum and sodium causes a safety concern due to the reaction with humidity to produce hydrogen.
the process generates a high-pH solid residue comprising carbon, silica, alumina and other oxides. The solid residue is difficult to valorize or recycle. For this reason, the residue is discarded in a specialty landfill.
some suggest floating carbon from this solid residue to recover a recyclable carbon powder for cathode manufacturing⁷. The suggestion implies floatation cells and various floatation agents. Nonetheless, recycled carbon from SPL might not comply with composition, morphology and structure specifications for use as carbon material in the aluminum smelter⁸.

Thus, the major drawback of the LCL&L process is that it does not reduce the amount of solid wastes (1.17 kg solid by-product per 1 kg SPL), not counting all the liquid wastes. The process literally creates a new type of solid waste with a different decontamination challenge.

Thermal destruction: SPL decontamination and carbon valorization via a burner-powered thermal treatment

The other major current alternative process to SPL landfilling is the thermal degradation of SPL and the mechanical sorting of the degraded solid residue. The alternative process degrades the cyanides, volatilises the acid components and produces an inert sand from a SPL feedstock. The sand is sorted into carbon and refractories in a subsequent processing step to manufacture valuable by-products for the cement industry.

This process alternative is the basis of a commercial process that produces specialty carbon bricks and specialty inorganic salts from SPL⁹. The process is being used in Australia since the early 2000s and its major advantage is that it is mostly dry.

This process is well established but suffers drawbacks as well:
the main market for these bricks is cement and brick manufacturing. This bottleneck is a major drawback since these industries tolerate only a small composition window for fluorine (0.25 wt % F max.¹⁰). It is an issue since part of the SPL fluorine content is not even volatile (i.e. CaF₂).
the by-product bricks from the process must comply with heavy international regulations to be sold as industrial-grade products.
the process requires additive supplies to meet cement and brick manufacturers requirements and to fully neutralize the solid residue.
the SPL feedstock must be fine-crushed to 50 μm-20 mm and sorted to get the right process recipe prior to thermal degradation at 450° C. However, at that temperature, the hot sand tends to partly melt thus agglomerating the fine-crushed SPL into larger chunks.
the hot sand resulting from thermal degradation at 450° C. must be quenched with water to volatilize the acid components, such as hydrogen fluoride (HF) and carbon monoxide (CO).
after that, the wet sand is exposed to air for up to 4 weeks to complete the stabilization before further processing. Such a long stabilization step oxidizes the other SPL volatile compounds, such as methane. A large closed hangar with an air treatment is thus required.
the multi-step process produces various off gases of different compositions and temperatures, which must be fully treated before release to the environment.

Here again, the major drawback of this batch-mode process is that it does not lower the amount of solid wastes.

Therefore, it would be desirable to provide an apparatus and a process that provide a reliable solution to the above problem afflicting core aluminum manufacturing processes.

### SUMMARY

It would thus be desirable to provide a novel apparatus and process for converting Spent Pot Lining (SPL) into inert slag, aluminum fluoride (AlF₃) and energy.

The embodiments described herein provide in one aspect a process for converting spent pot linings (SPL), comprising a plasma arc furnace, a dry syngas cleaning train and an aluminum fluoride (AlF₃) reactor,

a. the plasma arc furnace including an anode and a cathode, wherein:

i. the plasma arc furnace is adapted to gasify carbon to syngas;

ii. the plasma arc furnace is adapted to convert a mineral fraction to vitrified slag;

iii. steam is used to capture an excess energy from a gasification reaction and contributes to raise a syngas hydrogen content;

b. a cyclone at an outlet of the plasma arc furnace being adapted to collect dust particles;

c. the reactor being adapted to convert hydrogen fluoride (HF) in the syngas to AlF₃;

d. a waste heat boiler being adapted to cool down the syngas and to be possibly used for energy recovery;

e. a baghouse is adapted to recover at least part of the dust particles not recovered by the cyclone, wherein the dry syngas typically has a very low dew point, avoiding condensation

Also, the embodiments described herein provide in another aspect a process, wherein a temperature of the plasma arc furnace is between 500° C. and 1800° C.

Furthermore, the embodiments described herein provide in another aspect a process, wherein a vitrification of inert constituents of the SPL is carried out without requiring adding a slag agent, such as calcium oxide.

Furthermore, the embodiments described herein provide in another aspect a process, wherein a conversion of HF to AlF₃ is adapted to take place at a temperature higher than 500° C. but below 1000° C.

Furthermore, the embodiments described herein provide in another aspect a process, wherein a source of Al₂F₃ to produce AlF₃ is feed material to an aluminum electrolyser, purified Al₂F₃, or an intermediary aluminum hydroxide in a Bayer process.

Furthermore, the embodiments described herein provide in another aspect a process, wherein the reaction heat produced by a neutralisation of HF by Al₂F₃ is adapted to produce more steam in a heat recovery boiler (for instance HX-0411).

Furthermore, the embodiments described herein provide in another aspect a process, wherein any excess heat from the gasification of SPL in the plasma arc furnace is adapted to be used for converting water vapor (steam) or liquid water to hydrogen.

Furthermore, the embodiments described herein provide in another aspect a process, wherein the water is bled from the condensate-steam loop that flows in the waste heat recovery boiler (HX-0411).

Furthermore, the embodiments described herein provide in another aspect a process, wherein an oxidizing medium includes a mixture of air and water.

Furthermore, the embodiments described herein provide in another aspect a process, wherein a hydrogenation of fluorine volatized from the SPL is achieved via steam reaction.

Furthermore, the embodiments described herein provide in another aspect a process, wherein the slag can be valorized as a concrete additive.

Furthermore, the embodiments described herein provide in another aspect a process, wherein the plasma SPL gasification and vitrification furnace is adapted to maintain a certain amount of feed material on top of a molten inorganic bath, ensuring a substantially complete temperature gradient in the plasma arc furnace, thereby allowing for drying, pyrolysis and partial combustion of the SPL.

Furthermore, the embodiments described herein provide in another aspect a process, wherein a plasma SPL processing system requires only electricity as its energy source, i.e. no fossil fuels.

Furthermore, the embodiments described herein provide in another aspect a process for converting spent pot linings (SPL) into inert slag, aluminum fluoride (AlF₃) and energy in the form of steam and syngas.

Furthermore, the embodiments described herein provide in another aspect a process, wherein the inert slag can be valorized as a concrete additive.

Furthermore, the embodiments described herein provide in another aspect a process for converting spent pot linings (SPL), comprising a plasma arc furnace, a dry syngas cleaning train and an aluminum fluoride (AlF₃) reactor,

a. the plasma arc furnace including an anode and a cathode, wherein:

i. the plasma arc furnace is adapted to gasify carbon to syngas;

ii. the plasma arc furnace is adapted to convert a mineral fraction to vitrified slag;

iii. steam is used to capture an excess energy from a gasification reaction and contributes to raise a syngas hydrogen content;

b. a cyclone at an outlet of the plasma arc furnace being adapted to collect dust particles;

c. the reactor being adapted to convert hydrogen fluoride (HF) in the syngas to AlF₃;

d. a waste heat boiler being adapted to cool down the syngas; and

e. a baghouse is adapted to recover at least part of the dust particles not recovered by the cyclone.

Furthermore, the embodiments described herein provide in another aspect a process, wherein a temperature of the plasma arc furnace is between 500° C. and 1800° C.

Furthermore, the embodiments described herein provide in another aspect a process, wherein a vitrification of inert constituents of the SPL is carried out without requiring adding a slag agent, such as calcium oxide.

Furthermore, the embodiments described herein provide in another aspect a process, wherein a conversion of HF to AlF₃ is adapted to take place at a temperature higher than 500° C. but below 1000° C.

Furthermore, the embodiments described herein provide in another aspect a process, wherein a source of Al₂F₃ to produce AlF₃ is feed material to an aluminum electrolyser, purified Al₂F₃, or an intermediary aluminum hydroxide in a Bayer process.

Furthermore, the embodiments described herein provide in another aspect a process, wherein reaction heat produced by a neutralisation of HF by Al₂F₃ is adapted to produce more steam in a heat recovery boiler (for instance HX-0411).

Furthermore, the embodiments described herein provide in another aspect a process, wherein any excess heat from the gasification of SPL in the plasma arc furnace is adapted to be used for converting water vapor (steam) or liquid water to hydrogen.

Furthermore, the embodiments described herein provide in another aspect a process, wherein water is bled from a condensate-steam loop that flows in a waste heat recovery boiler (HX-0411).

Furthermore, the embodiments described herein provide in another aspect a process, wherein an oxidizing medium includes a mixture of air and water.

Furthermore, the embodiments described herein provide in another aspect a process, wherein a hydrogenation of fluorine volatized from the SPL is achieved via steam reaction.

Furthermore, the embodiments described herein provide in another aspect a process, wherein the slag can be valorized as a concrete additive.

Furthermore, the embodiments described herein provide in another aspect a process, wherein the plasma SPL gasification and vitrification furnace is adapted to maintain a certain amount of feed material on top of a molten inorganic bath, ensuring a substantially complete temperature gradient in the plasma arc furnace, thereby allowing for drying, pyrolysis and partial combustion of the SPL.

Furthermore, the embodiments described herein provide in another aspect a process, wherein the process requires only electricity as its energy source, i.e. no fossil fuels.

Furthermore, the embodiments described herein provide in another aspect a process for converting spent pot linings (SPL), comprising a plasma arc furnace that includes an anode and a cathode, the plasma arc furnace being adapted to gasify carbon to syngas and to convert a mineral fraction to vitrified slag, steam being provided to capture an excess energy from a gasification reaction and contributes to raise a syngas hydrogen content.

Furthermore, the embodiments described herein provide in another aspect a process, wherein a cyclone provided at an outlet of the plasma arc furnace is adapted to collect dust particles.

Furthermore, the embodiments described herein provide in another aspect a process, wherein a AlF₃ reactor is adapted to convert hydrogen fluoride (HF) in the syngas to AlF₃.

Furthermore, the embodiments described herein provide in another aspect a process, wherein a waste heat boiler is provided for cooling down the syngas.

Furthermore, the embodiments described herein provide in another aspect a process, wherein a baghouse is provided for recovering at least part of the dust particles not recovered by the cyclone.

Furthermore, the embodiments described herein provide in another aspect a process, wherein a temperature of the plasma arc furnace is between 500° C. and 1800° C.

Furthermore, the embodiments described herein provide in another aspect a process, wherein a vitrification of inert constituents of the SPL is carried out without requiring adding a slag agent, such as calcium oxide.

Furthermore, the embodiments described herein provide in another aspect a process, wherein a conversion of HF to AlF₃ is adapted to take place at a temperature higher than 500° C. but below 1000° C.

Furthermore, the embodiments described herein provide in another aspect a process, wherein a source of Al₂F₃ to produce AlF₃ is feed material to an aluminum electrolyser, purified Al₂F₃, or an intermediary aluminum hydroxide in a Bayer process.

Furthermore, the embodiments described herein provide in another aspect a process, wherein reaction heat produced by a neutralisation of HF by Al₂F₃ is adapted to produce more steam in a heat recovery boiler (for instance HX-0411).

Furthermore, the embodiments described herein provide in another aspect a process, wherein any excess heat from the gasification of SPL in the plasma arc furnace is adapted to be used for converting water vapor (steam) or liquid water to hydrogen.

Furthermore, the embodiments described herein provide in another aspect a process, wherein water is bled from a condensate-steam loop that flows in a waste heat recovery boiler (HX-0411).

Furthermore, the embodiments described herein provide in another aspect a process, wherein an oxidizing medium includes a mixture of air and water.

Furthermore, the embodiments described herein provide in another aspect a process, wherein a hydrogenation of fluorine volatized from the SPL is achieved via steam reaction.

Furthermore, the embodiments described herein provide in another aspect a process, wherein the slag can be valorized as a concrete additive.

Furthermore, the embodiments described herein provide in another aspect a process, wherein the plasma SPL gasification and vitrification furnace is adapted to maintain a certain amount of feed material on top of a molten inorganic bath, ensuring a substantially complete temperature gradient in the plasma arc furnace, thereby allowing for drying, pyrolysis and partial combustion of the SPL.

Furthermore, the embodiments described herein provide in another aspect a process, wherein the process requires only electricity as its energy source, i.e. no fossil fuels.

Furthermore, the embodiments described herein provide in another aspect an apparatus for converting spent pot linings (SPL), comprising a plasma arc furnace, an anode, a cathode, a crucible in the plasma arc furnace for receiving the SPL, the plasma arc furnace being adapted to generate an electric arc traveling from the anode to the cathode and within the SPL.

Furthermore, the embodiments described herein provide in another aspect an apparatus, wherein the plasma arc furnace is adapted to gasify carbon to syngas and to convert a mineral fraction to vitrified slag, steam being provided to capture an excess energy from a gasification reaction and contributes to raise a syngas hydrogen content.

Furthermore, the embodiments described herein provide in another aspect an apparatus, wherein a cyclone provided at an outlet of the plasma arc furnace is adapted to collect dust particles.

Furthermore, the embodiments described herein provide in another aspect an apparatus, wherein a AlF₃ reactor is adapted to convert hydrogen fluoride (HF) in the syngas to AlF₃.

Furthermore, the embodiments described herein provide in another aspect an apparatus, wherein a waste heat boiler is provided for cooling down the syngas.

Furthermore, the embodiments described herein provide in another aspect an apparatus, wherein a baghouse is provided for recovering at least part of the dust particles not recovered by the cyclone.

Furthermore, the embodiments described herein provide in another aspect an apparatus, wherein a temperature of the plasma arc furnace is between 500° C. and 1800° C.

Furthermore, the embodiments described herein provide in another aspect an apparatus, wherein a vitrification of inert constituents of the SPL is carried out without requiring adding a slag agent, such as calcium oxide.

Furthermore, the embodiments described herein provide in another aspect an apparatus, wherein a conversion of HF to AlF₃ is adapted to take place at a temperature higher than 500° C. but below 1000° C.

Furthermore, the embodiments described herein provide in another aspect an apparatus, wherein a source of Al₂F₃ to produce AlF₃ is feed material to an aluminum electrolyser, purified Al₂F₃, or an intermediary aluminum hydroxide in a Bayer process.

Furthermore, the embodiments described herein provide in another aspect an apparatus, wherein reaction heat produced by a neutralisation of HF by Al₂F₃ is adapted to produce more steam in a heat recovery boiler (for instance HX-0411).

Furthermore, the embodiments described herein provide in another aspect an apparatus, wherein any excess heat from the gasification of SPL in the plasma arc furnace is adapted to be used for converting water vapor (steam) or liquid water to hydrogen.

Furthermore, the embodiments described herein provide in another aspect an apparatus, wherein water is bled from a condensate-steam loop that flows in a waste heat recovery boiler (HX-0411).

Furthermore, the embodiments described herein provide in another aspect an apparatus, wherein an oxidizing medium includes a mixture of air and water.

Furthermore, the embodiments described herein provide in another aspect an apparatus, wherein a hydrogenation of fluorine volatized from the SPL is achieved via steam reaction.

Furthermore, the embodiments described herein provide in another aspect an apparatus, wherein the slag can be valorized as a concrete additive.

Furthermore, the embodiments described herein provide in another aspect an apparatus, wherein the plasma SPL gasification and vitrification furnace is adapted to maintain a certain amount of feed material on top of a molten inorganic bath, ensuring a substantially complete temperature gradient in the plasma arc furnace, thereby allowing for drying, pyrolysis and partial combustion of the SPL.

Furthermore, the embodiments described herein provide in another aspect an apparatus, wherein the apparatus requires only electricity as its energy source, i.e. no fossil fuels.

### BRIEF DESCRIPTION OF THE DRAWINGS

For a better understanding of the embodiments described herein and to show more clearly how they may be carried into effect, reference will now be made, by way of example only, to the accompanying drawings, which show at least one exemplary embodiment, and in which:

FIG. 1 is a schematic representation of an aluminum production electrolytic cell, wherein a cell wall becomes a cumbersome waste stream that piles up to 25,000 tons of SPLs (Spent Pot Lining) per year per aluminum smelter³;

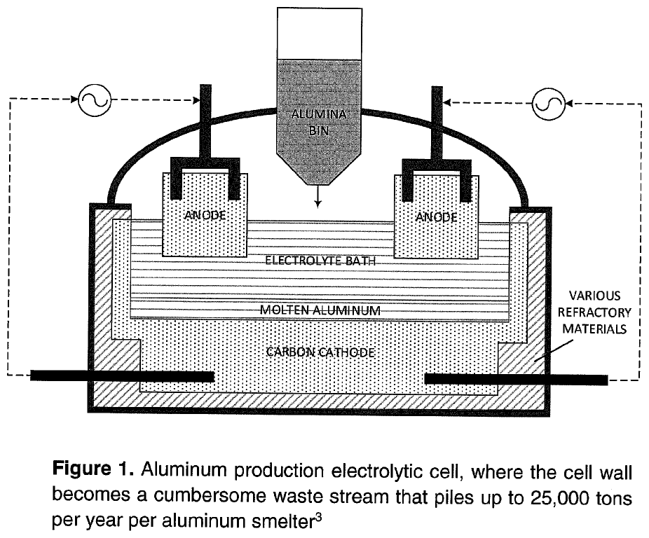

FIG. 2 is a schematic representation of an apparatus in accordance with an exemplary embodiment, which apparatus includes a plasma arc furnace; and

FIG. 3 is a schematic representation of an integration of the present apparatus and the plasma arc furnace thereof into a dry SPL decontamination process, in accordance with an exemplary embodiment.

### DESCRIPTION OF VARIOUS EMBODIMENTS

The new plasma technology described herein and using plasma provides a reliable solution to a problem afflicting the core aluminum manufacturing process.

The above overview of the two current alternative processes to landfilling stresses out what should be an optimal SPL treatment process. An optimal SPL treatment process would respond to four (4) major criteria.

These criteria are the following:

1. to generate a harmless solid by-product that can be easily discarded in any landfill.

2. to valorize the SPL carbon on-site for its energy content and thus to reduce the purchase of natural gas or other procured fuel.

3. to recover the SPL fluoride value for reuse on-site, without the need to comply with external regulations and without the need to buy a reagent to capture fluoride (such as calcium oxide).

4. to be a continuous process occupying a small footprint on the smelter site.

The fluorine recovery, as a valuable by-product reusable on-site, is key in the optimal SPL treatment process. Not all plasma technologies would deliver on fluorine recovery. For instance, some technologies trap the fluorine in their residual solid by-product via reaction with the reagent calcium oxide¹¹. This approach requires the mixing of SPL with neutralisation and fluxing reagents as a first step to their process. The ratio of added reagents to SPL can be as high as 50%.

The thermal destruction of waste via plasma described herein responds to these four (4) criteria and does not need outsourced fluxing agents nor neutralisation reagents.

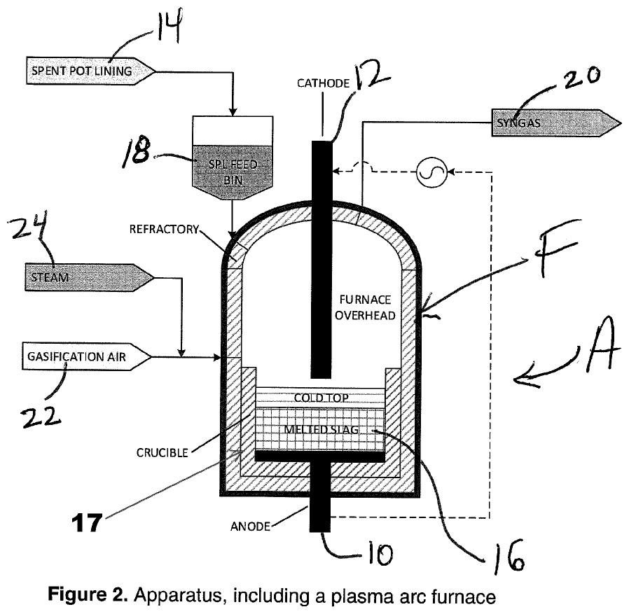

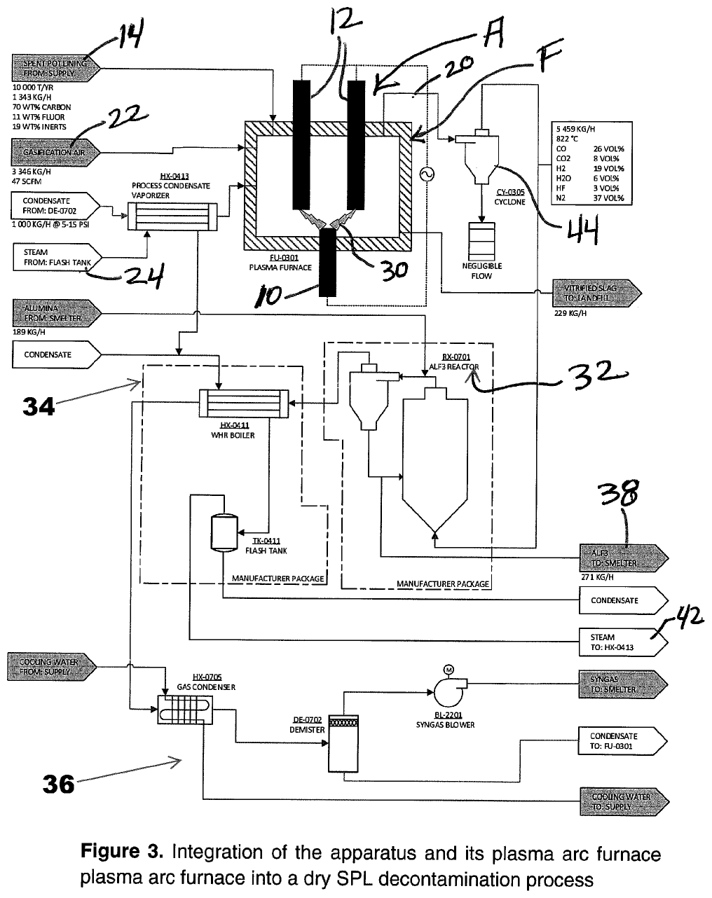

Therefore, as shown in FIG. 2, an apparatus A is provided for converting Spent Pot Lining (SPL) into inert slag, aluminum fluoride (AlF₃) and energy. The apparatus A includes a plasma arc furnace F such that the destruction of SPL occurs in this plasma arc furnace F. The furnace F uses electricity to generate an electric arc 30 (see FIG. 3) within the waste. The arc 30 travels from an anode 10 to a cathode 12 and destroys the waste due to the arc's extreme local temperature (5,000° C.). The extreme temperature that exists locally around the arc 30 converts the mineral fraction of SPL 14 into vitrified inert slag 16 lying within a crucible 17, which SPL 14 is fed via a feed bin 18. The slag 16 is very similar to obsidian, a natural-occurring mineral.

The furnace F gasifies the carbon content of the SPL 14 and produces a well-balanced syngas 20. The gasification takes place due to the controlled intake of air 22 and steam 24 to the furnace F. Gasification is the process of converting carbonaceous matter into a gaseous mixture of carbon monoxide (CO) and hydrogen (H₂). The gasification reaction liberates a significant amount of energy. Steam captures this excess energy, provides part of the oxygen requirement for gasification and contributes to raise the syngas H₂ content. Steam also contributes to the conversion of some SPL fluorides (NaF and Al₂F₃) into hydrogen fluoride.

The plasma process operates either in a continuous mode or in a semi-continuous mode. SPL 14 feeds into the furnace F continuously and syngas 20 continuously evolves from the furnace F. The slag 16, on the other hand, does not need to be poured out of the furnace continuously. The pouring of the slag 16 out of the furnace F can occur at a predetermined frequency, during which the feeding (of SPL 14, steam 24 and air 22) to the furnace F is idle.

As to the integration of the apparatus A and the plasma arc furnace F thereof into a complete SPL treatment process, the present apparatus A and its plasma arc furnace F greatly simplify the process of SPL decontamination, energy recovery, contaminant control and process integration within an aluminum smelter (see FIG. 3). The only downstream equipment to the furnace F that the process requires is that needed for the treatment of the syngas 20. The process assumes the cleaned syngas displaces natural gas in the anode baking area—a major energy consumer in any aluminum smelter.

Regarding the treatment of the syngas 20, in order to maintain robust and simple operations, the syngas treatment process is entirely dry from the feed inlet to the clean syngas delivery to the smelter. The major process units are an aluminum fluoride (ALF₃) reactor 32, a syngas cooler 34 and a baghouse 36.

The following describes these three (3) major process units:

The AlF₃ reactor 32 converts the hydrogen fluoride (HF) in the syngas 20 into a highly valuable by-product aluminum fluoride 38. The AlF₃ reactor 32 uses alumina (Al₂O₃) as reagent, which is the raw material to any aluminum smelter. Such reactors are available commercially to produce AlF₃.

The waste heat boiler (syngas cooler) 34 cools down the temperature of the syngas 20 from about 850° C. to 150° C. and by doing so, produces steam 42. The steam 42 is used for energy recovery and, for instance, to vaporize process water into the furnace F. Alternatively, the steam 42 can also feed a non-condensing steam turbine to generate electricity.

The baghouse 36 recovers any dust particles that neither a cyclone 44 at the outlet of the furnace F nor the AlF₃ reactor 32 could capture. The baghouse uses regular particle bags to capture the dust. The dry syngas has a very low dew point. Thus, the syngas flowing through the baghouse is not prone to condensation.

It is noted that the flowsheet of FIG. 3 assumes that the smelter is already equipped with a flue gas treatment plant to capture any remaining HF traces. HF traces do not pose any problem in the anode baking process.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the embodiments and non-limiting, and it will be understood by persons skilled in the art that other variants and modifications may be made without departing from the scope of the embodiments as defined in the claims appended hereto.

### REFERENCES

[1] Burry, L., Leclerc, S. and Poirier, S. (2016). The LCL&L Process: A Sustainable Solution for the Treatment and Recycling of Spent Potlining. In Light Metals 2016, E. Williams (Ed.). doi:10.1002/9781119274780.ch77, p. 467.
[2] Ullmann Encyclopedia (2009), chapter “Aluminum”, section 6.3, p. 30.
[3] Assuming 25 kg SPL per metric ton of primary aluminum and a maximum aluminum smelter capacity of 1,000,000 metric tons per year. Web site: https://gulfbusiness.com/top-10-largest-aluminium-smelters-in-the-world/, accessed 2020-03-04.
[4] Suss, A et al. (2015) Issues of spent carbon potlining processing. Paper presented at the 33 Conf of ICSOBA, Dubai, 28 Nov.-2 Dec. 2015.
[5] Birry, L., Leclerc, S. and Poirier, S. (2016). The LCL&L Process: A Sustainable Solution for the Treatment and Recycling of Spent Potlining. In Light Metals 2016, E. Williams (Ed.). doi:10.1002/9781119274780.ch77.
[6] Burry, L., Leclerc, S. and Poirier, S. (2016). “The LCL&L Process: A Sustainable Solution for the Treatment and Recycling of Spent Potlining”. In Light Metals 2016, E. Williams (Ed.). doi:10.1002/9781119274780.ch77.
[7] Pawlek R. P. (2018) “SPL: An Update”. In: Martin 0. (eds) Light Metals 2018. TMS 2018. The Minerals, Metals & Materials Series. Springer, p. 671.
[8] Pawlek R. P. (2012) “Spent Potlining: an Update”. In: Suarez C. E. (eds) Light Metals 2012. Springer, p. 1313.
[9] Cooper B. J., et al. (2009), Regain Technologies Pty Ltd. U.S. Pat. No. 7,594,952 B2, “Treatment of Smelting By-Products”.
[10] Pawlek R. P. (2018) “SPL: An Update”. In: Martin 0. (eds) Light Metals 2018. TMS 2018. The Minerals, Metals & Materials Series. Springer, p. 671.
[11] Chapman C., et al. (2010), Tetronics Limited. US Patent Publication No. US2010/0137671 A1, “Method for Treating Spent Pot Liner”.

1. A process for converting spent pot linings (SPL), comprising a plasma arc furnace, a dry syngas cleaning train and an aluminum fluoride (AlF₃) reactor,
a. the plasma arc furnace including an anode and a cathode, wherein:
i. the plasma arc furnace is adapted to gasify carbon to syngas;
ii. the plasma arc furnace is adapted to convert a mineral fraction to vitrified slag;
iii. steam is used to capture an excess energy from a gasification reaction and contributes to raise a syngas hydrogen content;
b. a cyclone at an outlet of the plasma arc furnace being adapted to collect dust particles;
c. the reactor being adapted to convert hydrogen fluoride (HF) in the syngas to AlF₃;
d. a waste heat boiler being adapted to cool down the syngas and to be possibly used for energy recovery;
e. a baghouse is adapted to recover at least part of the dust particles not recovered by the cyclone, wherein the dry syngas typically has a very low dew point, avoiding condensation.

2. The process according to claim 1, wherein a temperature of the plasma arc furnace is between 500° C. and 1800° C.

3. The process according to claim 1, wherein a vitrification of inert constituents of the SPL is carried out without requiring adding a slag agent, such as calcium oxide.

4. The process according to claim 1, wherein a conversion of HF to AlF₃ is adapted to take place at a temperature higher than 500° C. but below 1000° C.

5. The process according to claim 1, wherein a source of Al₂F₃ to produce AlF₃ is feed material to an aluminum electrolyser, purified Al₂F₃, or an intermediary aluminum hydroxide in a Bayer process.

6. The process according to claim 4, wherein the reaction heat produced by a neutralisation of HF by Al₂F₃ is adapted to produce more steam in a heat recovery boiler (for instance HX-0411).

7. The process according to claim 1, wherein any excess heat from the gasification of SPL in the plasma arc furnace is adapted to be used for converting water vapor (steam) or liquid water to hydrogen.

8. The process according to claim 5, wherein the water is bled from the condensate-steam loop that flows in the waste heat recovery boiler (HX-0411).

9. The process according to claim 1, wherein an oxidizing medium includes a mixture of air and water.

10. The process according to claim 1, wherein a hydrogenation of fluorine volatized from the SPL is achieved via steam reaction.

11. The process according to claim 1, wherein the slag can be valorized as a concrete additive.

12. The process according to claim 1, wherein the plasma SPL gasification and vitrification furnace is adapted to maintain a certain amount of feed material on top of a molten inorganic bath, ensuring a substantially complete temperature gradient in the plasma arc furnace, thereby allowing for drying, pyrolysis and partial combustion of the SPL.

13. The process according to claim 1, wherein a plasma SPL processing system requires only electricity as its energy source, i.e. no fossil fuels.

14. A process for converting spent pot linings (SPL) into inert slag, aluminum fluoride (AlF₃) and energy in the form of steam and syngas.

15. The process according to claim 14, wherein the inert slag can be valorized as a concrete additive.

16. A process for converting spent pot linings (SPL), comprising a plasma arc furnace, a dry syngas cleaning train and an aluminum fluoride (AlF₃) reactor,
a. the plasma arc furnace including an anode and a cathode, wherein:
i. the plasma arc furnace is adapted to gasify carbon to syngas;
ii. the plasma arc furnace is adapted to convert a mineral fraction to vitrified slag;
iii. steam is used to capture an excess energy from a gasification reaction and contributes to raise a syngas hydrogen content;
b. a cyclone at an outlet of the plasma arc furnace being adapted to collect dust particles;
c. the reactor being adapted to convert hydrogen fluoride (HF) in the syngas to AlF₃,
d. a waste heat boiler being adapted to cool down the syngas; and
e. a baghouse is adapted to recover at least part of the dust particles not recovered by the cyclone.

17. The process according to claim 16, wherein a temperature of the plasma arc furnace is between 500° C. and 1800° C.

18. The process according to any one of claims 16 to 17, wherein a vitrification of inert constituents of the SPL is carried out without requiring adding a slag agent, such as calcium oxide.

19. The process according to any one of claims 16 to 18, wherein a conversion of HF to AlF₃ is adapted to take place at a temperature higher than 500° C. but below 1000° C.

20. The process according to any one of claims 16 to 19, wherein a source of Al₂F₃ to produce AlF₃ is feed material to an aluminum electrolyser, purified Al₂F₃, or an intermediary aluminum hydroxide in a Bayer process.

21. The process according to any one of claims 16 to 20, wherein reaction heat produced by a neutralisation of HF by Al₂F₃ is adapted to produce more steam in a heat recovery boiler (for instance HX-0411).

22. The process according to any one of claims 16 to 21, wherein any excess heat from the gasification of SPL in the plasma arc furnace is adapted to be used for converting water vapor (steam) or liquid water to hydrogen.

23. The process according to any one of claims 16 to 22, wherein water is bled from a condensate-steam loop that flows in a waste heat recovery boiler (HX-0411).

24. The process according to any one of claims 16 to 23, wherein an oxidizing medium includes a mixture of air and water.

25. The process according to any one of claims 16 to 24, wherein a hydrogenation of fluorine volatized from the SPL is achieved via steam reaction.

26. The process according to any one of claims 16 to 25, wherein the slag can be valorized as a concrete additive.

27. The process according to any one of claims 16 to 26, wherein the plasma SPL gasification and vitrification furnace is adapted to maintain a certain amount of feed material on top of a molten inorganic bath, ensuring a substantially complete temperature gradient in the plasma arc furnace, thereby allowing for drying, pyrolysis and partial combustion of the SPL.

28. The process according to any one of claims 16 to 27, wherein the process requires only electricity as its energy source, i.e. no fossil fuels.

29. A process for converting spent pot linings (SPL), comprising a plasma arc furnace that includes an anode and a cathode, the plasma arc furnace being adapted to gasify carbon to syngas and to convert a mineral fraction to vitrified slag, steam being provided to capture an excess energy from a gasification reaction and contributes to raise a syngas hydrogen content.

30. The process according to claim 29, wherein a cyclone provided at an outlet of the plasma arc furnace is adapted to collect dust particles.

31. The process according to any one of claims 29 to 30, wherein a AlF₃ reactor is adapted to convert hydrogen fluoride (HF) in the syngas to AlF₃.

32. The process according to any one of claims 29 to 31, wherein a waste heat boiler is provided for cooling down the syngas.

33. The process according to any one of claims 29 to 32, wherein a baghouse is provided for recovering at least part of the dust particles not recovered by the cyclone.

34. The process according to any one of claims 29 to 33, wherein a temperature of the plasma arc furnace is between 500° C. and 1800° C.

35. The process according to any one of claims 29 to 34, wherein a vitrification of inert constituents of the SPL is carried out without requiring adding a slag agent, such as calcium oxide.

36. The process according to any one of claims 29 to 35, wherein a conversion of HF to AlF₃ is adapted to take place at a temperature higher than 500° C. but below 1000° C.

37. The process according to any one of claims 29 to 36, wherein a source of Al₂F₃ to produce AlF₃ is feed material to an aluminum electrolyser, purified Al₂F₃, or an intermediary aluminum hydroxide in a Bayer process.

38. The process according to any one of claims 29 to 37, wherein reaction heat produced by a neutralisation of HF by Al₂F₃ is adapted to produce more steam in a heat recovery boiler (for instance HX-0411).

39. The process according to any one of claims 29 to 38, wherein any excess heat from the gasification of SPL in the plasma arc furnace is adapted to be used for converting water vapor (steam) or liquid water to hydrogen.

40. The process according to any one of claims 29 to 39, wherein water is bled from a condensate-steam loop that flows in a waste heat recovery boiler (HX-0411).

41. The process according to any one of claims 29 to 40, wherein an oxidizing medium includes a mixture of air and water.

42. The process according to any one of claims 29 to 41, wherein a hydrogenation of fluorine volatized from the SPL is achieved via steam reaction.

43. The process according to any one of claims 29 to 42, wherein the slag can be valorized as a concrete additive.

44. The process according to any one of claims 29 to 43, wherein the plasma SPL gasification and vitrification furnace is adapted to maintain a certain amount of feed material on top of a molten inorganic bath, ensuring a substantially complete temperature gradient in the plasma arc furnace, thereby allowing for drying, pyrolysis and partial combustion of the SPL.

45. The process according to any one of claims 29 to 44, wherein the process requires only electricity as its energy source, i.e. no fossil fuels.

46. An apparatus for converting spent pot linings (SPL), comprising a plasma arc furnace, an anode, a cathode, a crucible in the plasma arc furnace for receiving the SPL, the plasma arc furnace being adapted to generate an electric arc traveling from the anode to the cathode and within the SPL.

47. The apparatus according to claim 46, wherein the plasma arc furnace is adapted to gasify carbon to syngas and to convert a mineral fraction to vitrified slag, steam being provided to capture an excess energy from a gasification reaction and contributes to raise a syngas hydrogen content.

48. The apparatus according to any one of claims 46 to 47, wherein a cyclone provided at an outlet of the plasma arc furnace is adapted to collect dust particles.

49. The apparatus according to any one of claims 46 to 48, wherein a AlF₃ reactor is adapted to convert hydrogen fluoride (HF) in the syngas to AlF₃.

50. The apparatus according to any one of claims 46 to 49, wherein a waste heat boiler is provided for cooling down the syngas.

51. The apparatus according to any one of claims 46 to 50, wherein a baghouse is provided for recovering at least part of the dust particles not recovered by the cyclone.

52. The apparatus according to any one of claims 46 to 51, wherein a temperature of the plasma arc furnace is between 500° C. and 1800° C.

53. The apparatus according to any one of claims 46 to 52, wherein a vitrification of inert constituents of the SPL is carried out without requiring adding a slag agent, such as calcium oxide.

54. The apparatus according to any one of claims 46 to 53, wherein a conversion of HF to AlF₃ is adapted to take place at a temperature higher than 500° C. but below 1000° C.

55. The apparatus according to any one of claims 46 to 54, wherein a source of Al₂F₃ to produce AlF₃ is feed material to an aluminum electrolyser, purified Al₂F₃, or an intermediary aluminum hydroxide in a Bayer process.

56. The apparatus according to any one of claims 46 to 55, wherein reaction heat produced by a neutralisation of HF by Al₂F₃ is adapted to produce more steam in a heat recovery boiler (for instance HX-0411).

57. The apparatus according to any one of claims 46 to 56, wherein any excess heat from the gasification of SPL in the plasma arc furnace is adapted to be used for converting water vapor (steam) or liquid water to hydrogen.

58. The apparatus according to any one of claims 46 to 57, wherein water is bled from a condensate-steam loop that flows in a waste heat recovery boiler (HX-0411).

59. The apparatus according to any one of claims 46 to 58, wherein an oxidizing medium includes a mixture of air and water.

60. The apparatus according to any one of claims 46 to 59, wherein a hydrogenation of fluorine volatized from the SPL is achieved via steam reaction.

61. The apparatus according to any one of claims 46 to 60, wherein the slag can be valorized as a concrete additive.

62. The apparatus according to any one of claims 46 to 61, wherein the plasma SPL gasification and vitrification furnace is adapted to maintain a certain amount of feed material on top of a molten inorganic bath, ensuring a substantially complete temperature gradient in the plasma arc furnace, thereby allowing for drying, pyrolysis and partial combustion of the SPL.

63. The apparatus according to any one of claims 46 to 62, wherein the apparatus requires only electricity as its energy source, i.e. no fossil fuels.
